(19) United States
(12) Patent Application Publication
(10) Pub. No.: US 2005/0066299 A1
(43) Pub. Date: Mar. 24, 2005

(54) Method for arranging circuit elements in semiconductor components

(76) Inventor: Michael Wagner, Oberschweinbach (DE)

Correspondence Address: SLATER & MATSIL, L.L.P., 17950 PRESTON RD, SUITE 1000, DALLAS, TX, 75252-5793, US

(21) Appl. No.: 10/845,763

(22) Filed: May 14, 2004

(30) Foreign Application Priority Data
May 15, 2003 (DE) 103 22 088.7

(51) Int. Cl. G06F 17/50

(52) U.S. Cl. 716/9

(57) ABSTRACT

The problem of the invention, which concerns a method for arranging circuit elements in semiconductor components, in which according to a circuit draft, using a standard cell library, a physical layout is produced, in which the circuit elements are placed in the layout, one after the other, with their components, and with this layout, the circuit elements are structured in the semiconductor component, wherein each of the circuit elements has a driver, to which a driver strength is established, and connecting elements, is to indicate a method with which a placing of the circuit elements can be undertaken in such a way that a functionally reliable timing can be purposefully attained. This is attained in that the sensitivity of the circuit elements for a parasitic electromagnetic influencing is evaluated and in that the circuit elements with the highest sensitivity—that is, the susceptibility for parasitic influencing—are first placed with the shortest possible connecting elements.

The invention concerns a method for arranging circuit elements in semiconductor components, in which according to a circuit draft, a physical layout is produced, using a standard cell library, in which the circuit elements are placed in the layout, one after the other, with their components. With this layout, the circuit elements are structured in the semiconductor component, wherein each of the circuit elements has a driver, to which a driver strength is established, and connecting elements.

The placing of circuit elements with a “Place-and-Route” step is described in the “White Paper,” Company Publication, Profilific, 39899 Balentine Dr., Suite 380, Newark, Calif. 945560, 2001, www.profilificinc.com. The electrical circuit is thereby indicated first in a circuit draft. By means of a standard cell library, standard cells are then selected, and by means of these standard cells, the electrical circuit is connected downstream. Circuit elements are thereby converted into layout components by means of the Place-and-Route step, which, together, produce the layout, by means of which the individual semiconductor component is structured on a semiconductor disk.

The circuit elements contain a driver and connecting elements.

In the circuits, those with synchronous logic can be distinguished from those with nonsynchronous logic. Circuits with synchronous logic can be described clearly with regard to their dynamic behavior and for this reason, can also be easily converted into the layout, so that when operating the semiconductor element later, no dynamic influences of the circuit elements appear among one another, in particular via their connecting elements.

Circuits with nonsynchronous logic have a more problematic behavior. Here, an arrangement with circuit elements can only be effected by means of the empirical experience of a designer, in such a way that dynamic influences are, if possible, ineffective, and the time behavior (timing) of the circuit then corresponds to the requirements. In the end, the result can be attained only by experiments, and the operability can be tested only by simulation of the finished physical layout at a very late point in time, in the course of the design development. If the result turns out negative, then the expenditure up to then was in vain.

The problem of the invention consists in indicating a method with which a placing of the circuit elements can be undertaken in such a way that it is possible to purposefully attain a functionally reliable timing.

In accordance with the invention, the problem is solved in that the sensitivity of the circuit elements is evaluated for a parasitic influencing with regard to the conduction resistance and/or the conduction capacity and in that the circuit elements with the highest sensitivity—that is, susceptibility for parasitic influencing—are placed with the shortest possible connecting elements.

This ensures that the connecting elements of the components, which would experience a great dynamic influencing, are kept as short as possible. With a placing algorithm, a greater latitude in the placing still exists at the beginning of the placing, namely, than at a later point in time, when numerous circuit elements can already be placed and thus, perhaps, longer connecting elements must be selected, so as to connect the circuit elements with one another. If more sensitive circuit elements would be placed at a later point in time, it could affect the need for longer connecting elements and related to this, a greater susceptibility with regard to dynamic disturbances, which is avoided by the invention.

With another placing algorithm, the possibility exists of changing the placing, in accordance with priority, in repeatedly going through the placement algorithm (replacement).

In a variant of the method of the invention, provision is made so that the sensitivities of all circuit elements are determined, and the circuit elements with lower sensitivity are placed before circuit elements with greater sensitivity. Thus, the sensitivity which, in the end, is the cause of poor or useless timing according to the state of the art has a direct influence on the placing.

In a particularly favorable manner, the driver strength is used as the measure of the sensitivity. In actual practice, it has been shown that circuit elements with smaller drivers, or with low driver strengths, are particularly susceptible, so that the driver strength is particularly suitable as a measure of sensitivity.

For the course of the placing, it has proved particularly expedient to store network names of the circuit elements with a marking of the individual driver strength.

Finally, the possibility of undertaking the placing sequence with a separate determination course exists. From the driver strength, a placing rank is thereby calculated, and the circuit elements are placed in accordance with the placing rank. In particular, the placer can also have an influence on the sequence, in order to undertake corrections also, particularly with circuit elements with the same sensitivity.

The invention will be explained in more detail below with the aid of embodiment examples. The figures in the corresponding drawings show the following:

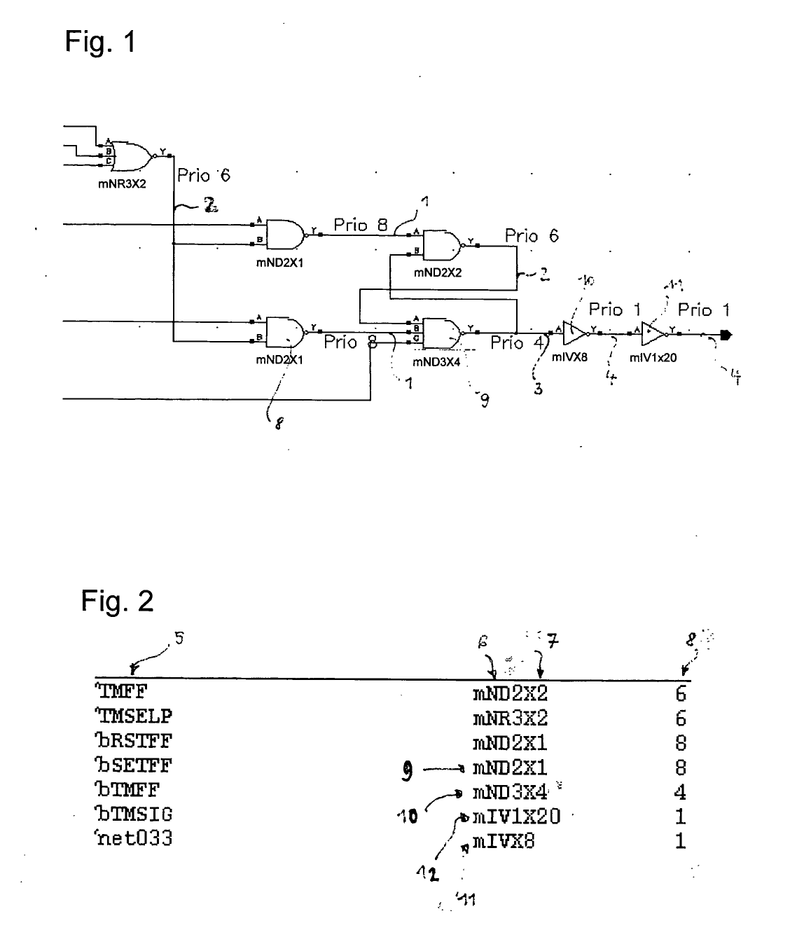

FIG. 1, a draft of an electrical circuit with different connecting elements;

FIG. 2, a list of the addresses of circuit elements, corresponding to FIG. 1 and the assignment of the placing; and

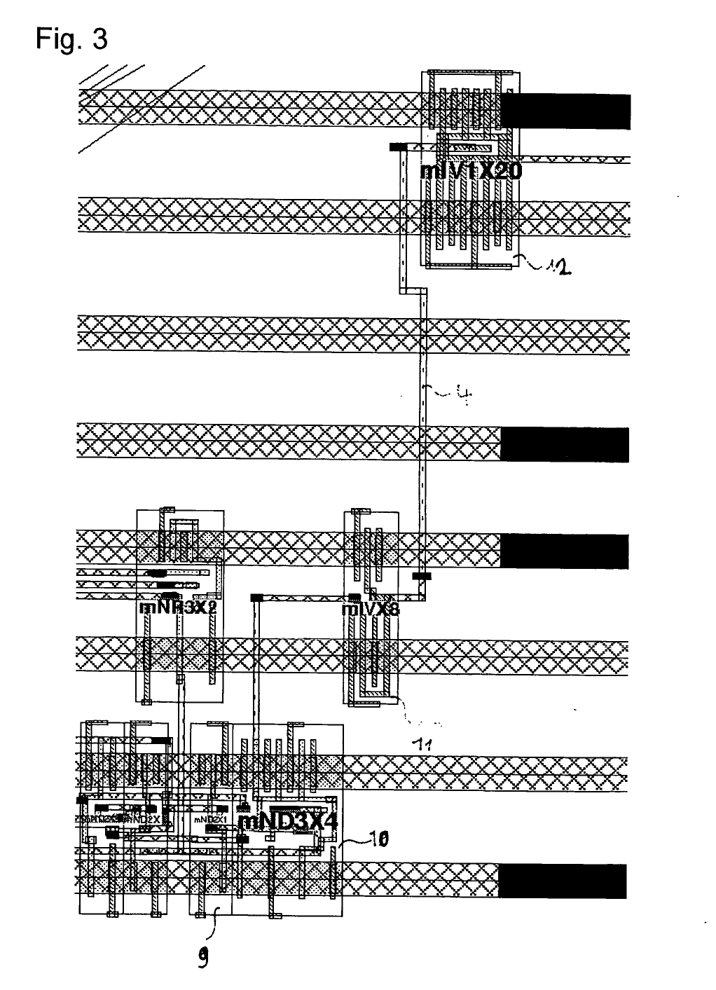

FIG. 3, an arrangement of the circuit elements in the layout and the assignment of the individual circuit elements with respect to one another.

FIG. 1 shows the circuit draft. Path 1, which is particularly endangered for a parasitic influencing, is provided with “Prio 8”; endangered path 2, with “Prio 6”; less endangered path 3, with “Prio 4”; and the uncritical Path 4, with “Prio 1.”

As can be seen from FIG. 2, a list with all circuit elements 5, which are connected with one another via connecting elements—that is, with network names 6 and their driver strengths 7—is automatically extracted according to the circuit draft—that is, according to the setup of the electrical draft. The driver strengths 7 are labeled with a number behind the letter “X,” wherein, for example, “X2” marks a low driver strength and “X8,” a driver strength which is large in comparison. In accordance with the invention, then, the paths with the low driver strength, for example, path 1 with the driver strength “X1,” then receive a higher priority 8—in the example “8,” which is indicated in the right column of the table according to FIG. 2—than the path with a comparatively greater driver strength—for example, path 4 with the priority “1” with a driver strength “X8.”

This information is given to the placer—that is, the placing algorithm or the program that implements the placing. The idea is thereby used that networks which are switched by small drivers, for example, with driver strength “X1,” are influenced much more intensely by parasitic wiring effects, such as by capacities and resistances of the layout, of which the designer of the circuit draft still has no knowledge, because they depend on the physical implementation, than networks driven by larger drivers, for example, with driver strength “X8.”

By the setting up of the list, it is possible for the placer to see, during the placing of the standard cells, that sensitive networks (small drivers) are designed as short as possible. Therefore, they have a higher priority in the placing process.

As shown, for example, in FIG. 3, it is important for the relatively weak driver of the standard cell 9, with the network name mND2X1, to be kept together with the corresponding standard cell 10 with the network name mND3X4, during the placing. On the other hand, path 4 from the standard cell 12 with the network name mIX8 to the corresponding standard cell 11 with the network name mIV1X20 is taken into consideration later during the placing, as a result of the relatively high driver strength “X8” and a low priority “1,” resulting therefrom, since it can have a greater length. In the placing course with storage circuits, practiced in accordance with the invention, this is guaranteed.

One could also assume that it is also possible to solve the problem by replacing the smaller drivers by stronger drivers. This possibility is eliminated, however, in that such a solution would inevitably result in an increased current consumption of the entire circuit. Furthermore, the area requirement would increase for the smaller drivers, since they would have to be replaced by larger drivers.

The advantage of the solution in accordance with the invention is to be found, in particular, in that the circuit performance is influenced by the wiring—that is, by the connecting elements. With smaller structural sizes, this becomes a greater and greater problem, so that the purposeful influencing of the connecting elements in accordance with the invention offers advantages here in the purposeful attainment of target parameters.

### Reference Symbol List

1 Greatly endangered path
2 Endangered path
3 Less strongly endangered path
4 Uncritical path
5 Circuit element
6 Network name
7 Driver strength
8 Priority
9 Standard cell mND2X1
10 Standard cell mND3X4
11 Standard cell mnIV1X20
12 Standard cell mIVX8

1. Method for arranging circuit elements in semiconductor elements, in which according to a circuit draft, using a standard cell library, a physical layout is produced, in which the circuit which the circuit elements are placed in the layout, one after the other, with their components, and with this layout, the circuit elements are structured in the semiconductor component, wherein each of the circuit elements has a driver, to which a driver strength is established, and connecting elements, wherein the sensitivity of the circuit elements for a parasitic influencing is evaluated and in that the circuit elements with a highest sensitivity are placed with the shortest possible connecting elements.

2. Method according to claim 1, wherein the sensitivities of all circuit elements are determined, and the circuit elements with lower sensitivity are placed before circuit elements with a greater sensitivity.

3. Method according to claim 1, wherein the driver strength is used as a measure of the sensitivity.

4. Method according to claim 3, wherein network names of the circuit elements are stored with a marking of the respective driver strength.

5. Method according to claim 4, wherein a placing rank is calculated from the driver strength, and the placing elements are placed in accordance with the placing rank.

6. A method of forming a semiconductor device, the method comprising:
providing a circuit diagram that includes a number of circuit elements that arc interconnected with one another, each circuit element including a driver;
determining a driver strength for the driver of each circuit element;
evaluating a sensitivity for each of the circuit elements, the sensitivity being related to a susceptibility to parasitic influencing; and
determining a physical layout for the circuit elements, the physical layout including electrical connections to and from ones of the circuit elements wherein a physical length of each electrical connection is determined based on the sensitivity of a circuit element that is connected to that electrical connection.

7. The method of claim 6 wherein the circuit elements comprise circuit elements selected from a standard cell library.

8. The method of claim 6 wherein determining a physical layout comprises placing each of the circuit elements one by one.

9. The method of claim 8 wherein ones of the circuit elements with lower sensitivity are placed before ones of the circuits with a higher sensitivity.

10. The method of claim 6 wherein evaluating a sensitivity comprises evaluating a sensitivity based on driver strength.

11. The method of claim 6 and further comprising generating a table, the table including a network name for each circuit element along with a driver strength for each network name.

12. The method of claim 11 and further comprising determining a placing rank from each driver strength, wherein determining a physical layout comprising placing each circuit element one by one in an order determined by the placing rank.

13. The method of claim 6 and further comprising manufacturing a semiconductor device based on the physical layout.

14. A method of forming a semiconductor device, the method comprising:
providing a circuit diagram that includes a number of interconnected circuit elements;
determining a drive strength for each circuit element;
determining a physical layout location for a first circuit element that has a lowest drive strength;
determining a physical layout location for a second circuit element that has a second to lowest drive strength; and
continuing to determine physical layout locations for each other element, the physical layout locations being determined in an order determined by drive strength wherein the location of circuit elements with a lower drive strength are determined before the location of circuit elements with a higher drive strength.

15. The method of claim 14 and further comprising fabricating a semiconductor device in accordance with the physical layout.

16. The method of claim 15 w*wherein the circuit elements comprising circuit elements selected from a standard cell library.

17. The method of claim 16 and further comprising generating a table, the table comprising a network name for each circuit element along with a driver strength for each network name.

18. The method of claim 14 wherein the circuit elements comprising circuit elements selected from a standard cell library.

19. The method of claim 14 and further comprising generating a table, the table comprising a network name for each circuit element along with a driver strength for each network name.

20. The method of claim 19 wherein the circuit elements comprising circuit elements selected from a standard cell library.
